(19) United States
(12) Patent Application Publication
(10) Pub. No.: US 2004/0205471 A1
(43) Pub. Date: Oct. 14, 2004

(54) Method and apparatus for setting control variables in a debugging mode of a machine programming and control system

(76) Inventors: Joseph Gasiorek, Ann Arbor, MI (US); Andrew H. McMillan, Dearborn, MI (US); Michael McFarland, Penobscot, ME (US); James B. Behm, Ann Arbor, MI (US); John Brandow, West Adrian, MI (US); Kurudi Muralidhar, Novi, MI (US)

Correspondence Address: HARNESS, DICKEY & PIERCE, P.L.C., P.O. BOX 828, BLOOMFIELD HILLS, MI, 48303, US

(21) Appl. No.: 10/188,225

(22) Filed: Jul. 2, 2002

Related U.S. Application Data
(60) Provisional application No. 60/302,610, filed on Jul. 2, 2001.

(51) Int. Cl. G06F 15/00

(52) U.S. Cl. 715/500

(57) ABSTRACT

A flowchart-based programming and control system includes a computer including a processor, memory and a display. A device is connected to the computer and is associated with a process. A flowcharting module run by the computer generates and edits a flowchart that includes flowchart blocks and that contains logic for operating the device to further the process. The flowcharting module includes a debugging mode that displays the flowchart and identifies a flowchart block that is currently being executed. The debugging mode displays a value of a control variable that is associated with a selected flowchart block. The debugging mode allows the value of the control variable to be changed, forced on, forced off, set to zero, and/or set to a new value.

### CROSS-REFERENCE TO RELATED APPLICATIONS

This application claims the benefit of U.S. Provisional Application No. 60/302,610, filed Jul. 2, 2001, which is hereby incorporated by reference.

### FIELD OF THE INVENTION

The present invention relates generally to machine programming and control systems, and more particularly, to method and apparatus for viewing and setting control variables in a debugging mode of a flowchart-based machine programming and control system.

### BACKGROUND OF THE INVENTION

Machine programming and control systems are generally used for controlling processes that involve devices such as relays, motors, solenoids, valves, switches and other electrical and electromechanical devices. Exemplary processes include machining, drilling, welding, material handling, and material assembly. Generally the machine programming and control systems are operated according to predefined control logic such as flowcharts, ladder diagrams and/or relay ladder logic.

After initially developing the control logic for the machine programming and control system, the programmer debugs the control logic to ensure that the control logic operates the devices in the intended manner. Debugging can also occur after implementation when the control logic is not performing in the intended manner. To properly debug the control logic, the programmer confirms that the control logic performs in the intended manner for all possible control variable values. Because it is currently difficult to test all possible combinations of the control variable values, debugging the control logic is often time consuming, difficult and incomplete.

During the debugging process, it is also difficult to know what the current value of a particular control variable is without physically checking the device. The current value may be needed so that the programmer can determine the cause for a control error. Finally, certain values for a control variable cannot be obtained during normal operation. These values are often required before control logic requiring the value will run.

### SUMMARY OF THE INVENTION

A flowchart-based programming and control system and method according to the present invention includes a computer including a processor, memory and a display. A device is connected to the computer and is associated with a process. A flowcharting module run by the computer generates and edits a flowchart that includes flowchart blocks and that contains logic for operating the device to further the process. The flowcharting module includes a debugging mode that displays the flowchart and identifies a flowchart block that is currently being executed. The debugging mode displays a value of a control variable that is associated with a selected flowchart block.

In other features of the invention, the debugging mode allows the value of the control variable to be changed, forced on, forced off, set to zero, and/or set to a new value.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a programming and control system that controls a process;

FIG. 2 is a functional block diagram illustrating the programming and control system of FIG. 1 in further detail;

FIG. 3 is a block diagram of an alternate programming and control system that includes an embedded controller;

FIG. 4 is a functional block diagram illustrating the alternate programming and control system of FIG. 3 in further detail;

FIG. 5 illustrates a graphical user interface for creating and debugging flowcharts;

FIG. 6 illustrates a first active debug dialog box;

FIG. 7 illustrates a second active debug dialog box;

FIG. 8 illustrates a third active debug dialog box; and

FIG. 9 illustrates a fourth active debug dialog box.

### DETAILED DESCRIPTION OF THE PREFERRED EMBODIMENT

The following description of the preferred embodiment(s) is merely exemplary in nature and is in no way intended to limit the invention, its application, or uses.

The machine programming and control system according to the present invention provides an improved environment for debugging flowcharts that contain control logic for operating devices that are associated with a process.

Debugging capabilities within industrial programming and control systems are a key component for controlling devices that are associated with the process. There is a need for web-based and remote debugging capabilities in the machine programming and control systems. The machine programming and control system according to the invention provides the ability to view and modify control variables remotely. Using dialog boxes, current values for control variables are displayed for a flowchart block that forms a part of a flowchart that is being debugged. The values of the control variables can be viewed, changed or forced to a value while viewing the flowchart using a flowchart module to assist in the debugging of the flowchart. By providing immediate feedback, the developers can debug the flowchart remotely and on a more timely basis.

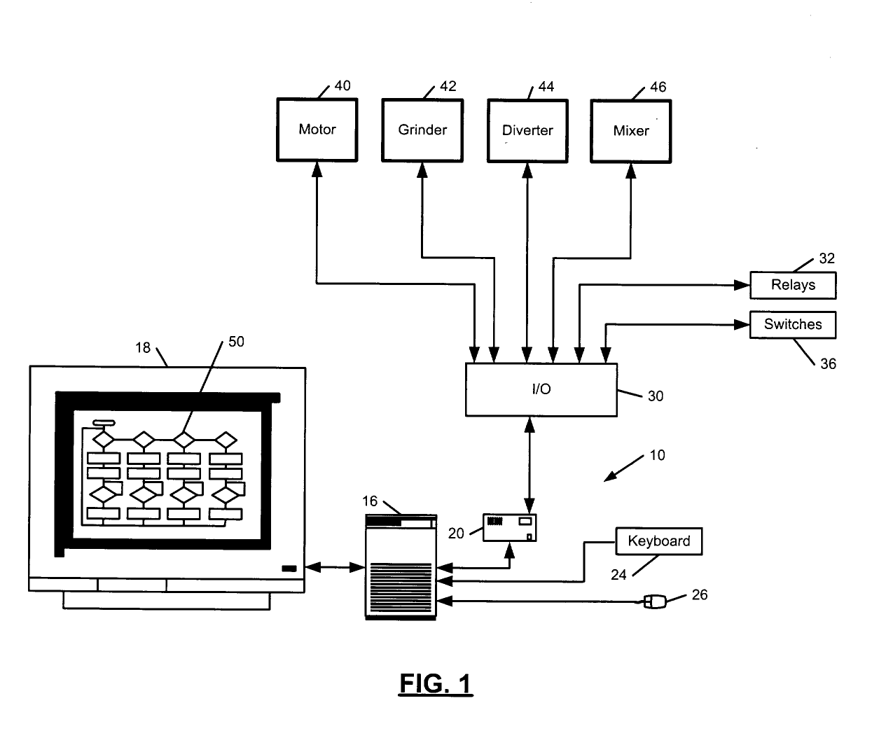

Referring now to FIG. 1, a machine programming and control system 10 includes a computer 16 that is connected to a display 18. The computer 16 includes an input/output (I/O) card 20 such as an Ethernet card, a keyboard 24 and a mouse 26. The computer 16 is connected to I/O network 30 such as an Ethernet network that is connected to a plurality of devices such as one or more relays 32, one or more switches 36, a motor 40, a grinder 42, a diverter 44, and a mixer 46. The computer 16 includes a flowchart module that provides a graphical user interface (GUI) for programming control logic that controls the devices to further a process. The flowchart module is located in memory that is associated with the computer 16. The flowchart module allows a user to generate a flowchart 50 on the display 18 using convention point and click techniques using the keyboard 24 and/or the mouse 26. Flowchart modules providing such functionality are disclosed in U.S. Pat. No. 4,852,047 hereby incorporated by reference.

While an Ethernet card and network are shown, other I/O cards and networks can be employed without departing from the spirit of the invention.

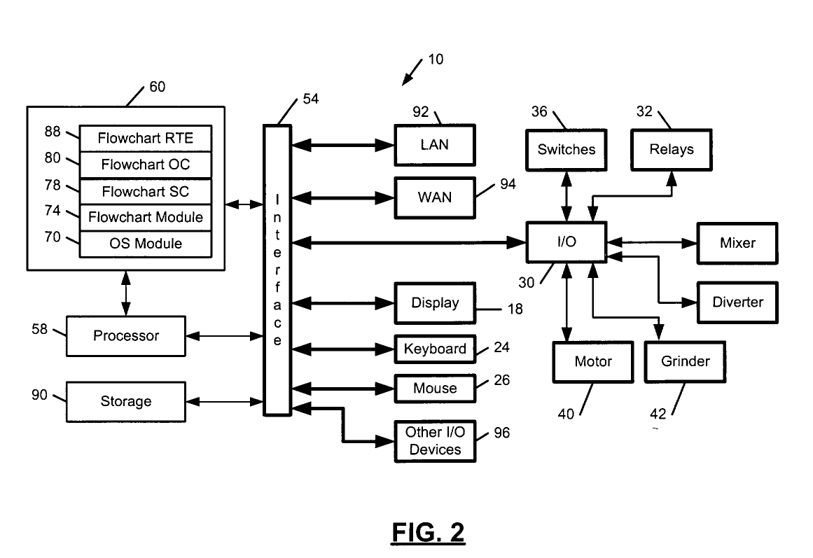

Referring now to FIG. 2, the programming and control system 10 includes an I/O interface 54 that is connected to a processor 58 and memory 60 which can include random access memory (RAM) and read-only memory (ROM). The memory 60 contains an operating system module 70 and a flowchart module 74. As a user creates, edits and modifies the flowchart 50, the flowchart module 74 generates flowchart source code 78. When the user completes the flowchart 50, the user compiles the flowchart source code 78 using the flowchart module 74 and creates the flowchart object code 80. The flowchart object code 80 is executed by a flowchart run time engine 88. The I/O interface 54 is also connected to a storage device such as a hard drive, floppy drive, optical storage, or other suitable electronic storage. The I/O interface 54 can also be connected to a local area network (LAN) 92 and/or a wide area network (WAN) 94.

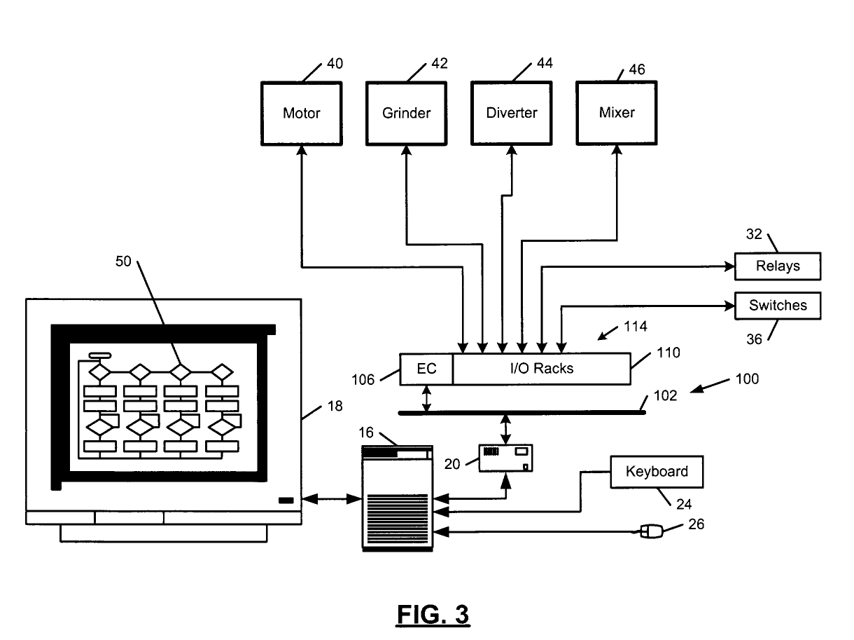

Referring now to FIG. 3, an alternate machine programming and control system 100 that allows a user to view, set and force control variables in a debugging mode is shown. Reference numbers from FIGS. 1 and 2 are used where appropriate. The machine programming and control system 100 includes a first computer 16 that is connected to the display 22, the keyboard 24 and the mouse 26. The input/output (I/O) card 30 such as an Ethernet card is connected in an expansion slot of the computer 16.

A communications network 102 such as an Ethernet network is connected to the I/O card 30. An embedded controller (EC) 106 is connected to the I/O network 102. I/O racks 110 are connected to the EC 106. Electrical and/or electromechanical devices are connected to the I/O racks 110. The exemplary devices include the motor 40, the grinder 42, the diverter 44, the mixer 46, one or more relays 32, and one or more switches 36. Skilled artisans can appreciate that other types of devices can be added to or substituted in the machine programming and control system 100 without departing from the spirit of the invention. Other I/O cards and networks are also contemplated. The computer 16 contains a flowchart module that creates, edits, and displays the flowcharts 50 on the display 18. The flowchart module generates flowchart source code that is compiled into flowchart object code directly from the flowchart.

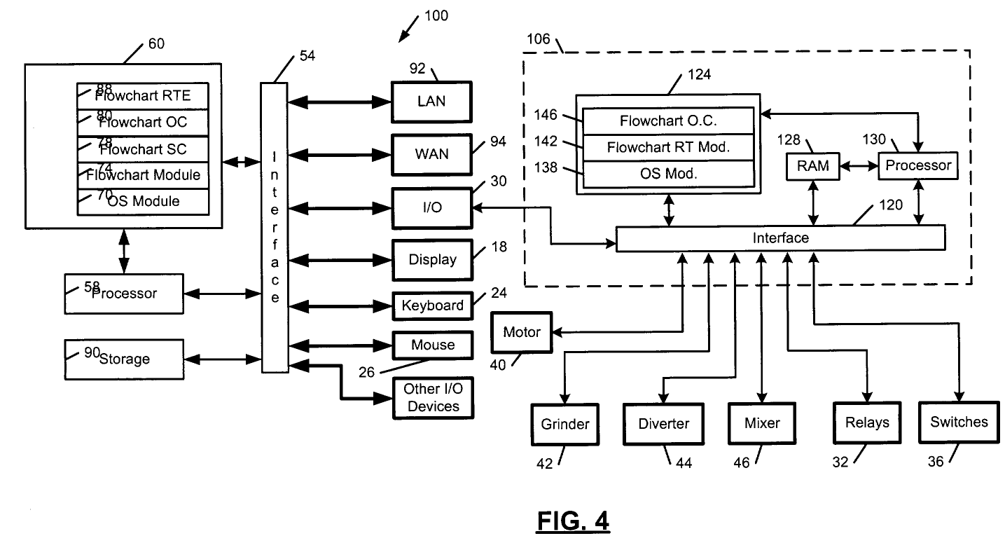

Referring now to FIG. 4, the programming and control system 10 is illustrated further and includes the I/O interface 54, the processor 58, and the memory 60 including random access memory (RAM) and read-only memory (ROM). After boot-up, an operating system 70 such as Windows NT®, Windows NTE®, Windows 2000®, Mac®-based operating systems, or other suitable operating systems and a flowchart module 74 are loaded into the memory 60. The flowchart module 74 allows a user to create, edit and display flowcharts 50. As the user generates the flowchart 50, the flowchart module 74 generates flowchart source code 78. When debugged and validated, the flowchart module 74 generates flowchart object code 80 that is generated from the flowchart source code 78.

The computer 16 is connected to a local area network (LAN) 92 and/or a wide area network (WAN) 94 which, in turn, can be connected to the Internet. One or more other I/O devices 96, such as a printer, scanner, etc., may also be connected to the interface 54.

The EC 106 includes an I/O interface 120, ROM 124, RAM 128, and a processor 130. The ROM 124 and/or RAM 128 contains an EC operating system 138, a flowchart run-time module or kernel 142, and flowchart object code 146. The EC 106 is preferably a Win PLC running Windows CE®. Preferably, the ROM 124 is flash ROM. The flowchart object code 146 is transmitted to the EC 106 through the I/O network 34 for execution by the flowchart run time module 142.

In use, a user launches the flowchart module 74 using the keyboard 24 and/or the mouse 26 when the user wants to create or to edit flowchart projects. The flowchart module 74 is loaded into the memory 60 of the computer 16. A user creates or edits the flowchart 50 for controlling the devices (the motor 40, the grinder 42, the diverter 44, the mixer 46, the switches 32, and the relays 36) that are associated with the process as will be described further below.

As the user creates the flowchart 50 on the screen, the computer 16 generates the flowchart source code 78 that is then saved in memory 60 or storage 90. After creation, debugging, and/or simulation is complete, the user compiles the flowchart source code 78 and generates the flowchart object code 80. In the machine programming and control system 10, the flowchart run-time engine 88 executes the flowchart object code 80 to control the devices. In the machine programming and control system 100, the flowchart run-time engine 142 executes the flowchart object code 146 that controls the devices connected to the EC 38.

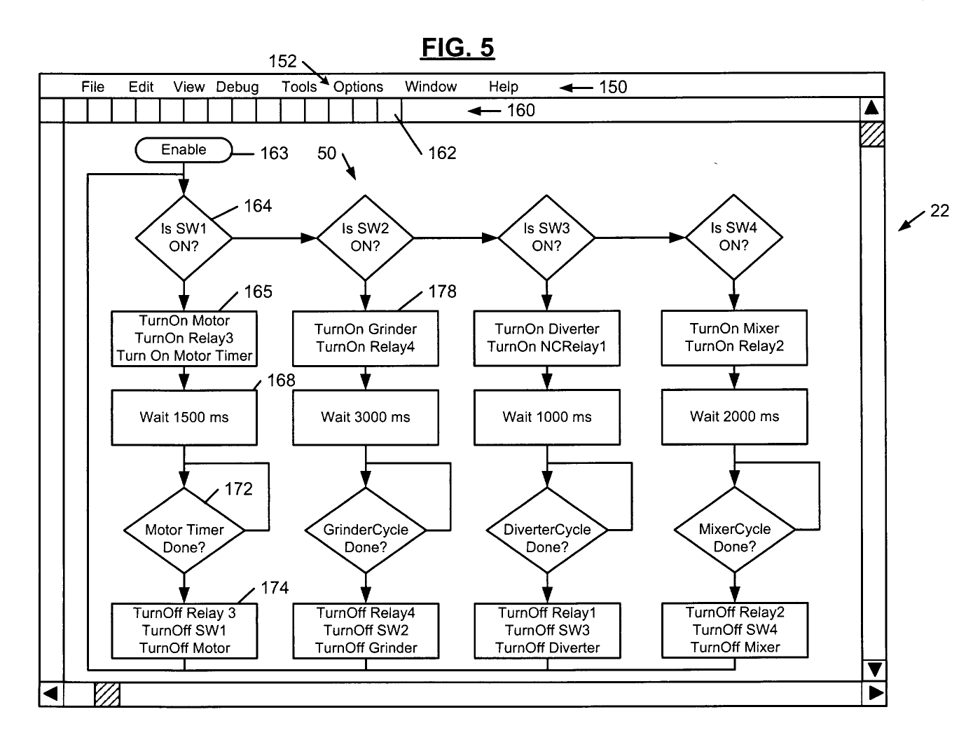

Referring now to FIG. 5, a graphical user interface that is associated with the display 18 is illustrated in further detail and includes a menu bar 150. The menu bar 150 includes drop-down menu items 152 that are operated in a conventional manner when a user points and clicks on the menu items 152. A toolbar 160 includes a plurality of tools 162 that are likewise operated in a conventional manner.

A user generates the flowchart 50 that includes an enable block 163, one or more decision blocks 164, and one or more action blocks 165 in a conventional manner. The flowchart 50 contains control logic for operating the devices. In the exemplary flowchart 50 illustrated in FIG. 3, control begins at the enable block 163. If a first switch that is associated with the motor 40 is on as determined at decision block 164, control turns on the motor 40, turns on a normally closed relay associated with the diverter 44 that prevents the diverter 44 from turning on, and turns on a motor timer. Control continues with action block 168 where control waits for 1,500 milliseconds and then continues with a decision block 172 where control determines whether the motor timer is up. If it is, the relay associated with the diverter 44 is turned off in action block 174. The switch associated with the motor 40 and the motor 40 are also turned off in action block 174. Additional flowchart logic associated with the flowchart 50 controls the operation of the devices (the grinder 42, the diverter 44, the mixer 46, the relays 32, and the switches 36) that are associated with the process in a similar manner.

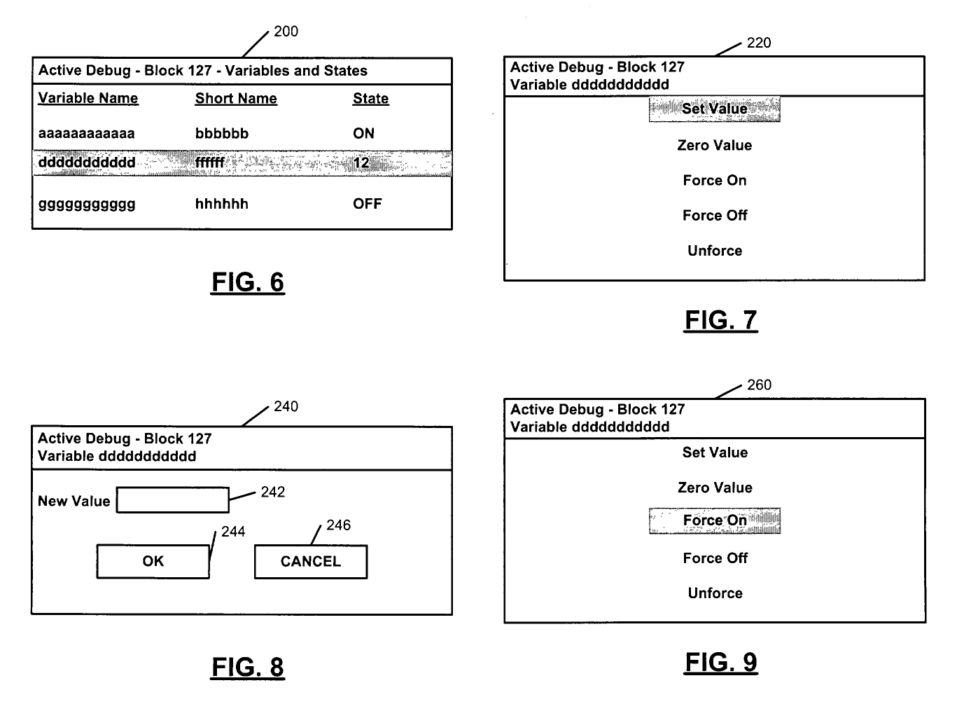

During a debug mode, the developer can monitor the operation of the control logic contained in the flowchart 50. The flowchart module uses colors, icons, fonts, and/or other mechanisms for identifying a logic block that is currently being executed. Referring now to FIG. 6, when a user left-clicks on one of the logic blocks in the flowchart, an active debug dialog box 200 is launched. Other methods of launching the active debug dialog box 200 are contemplated. For example, the active debug dialog box 200 can be launched by double-clicking on a logic block, by using the menu bar 150, by using the tool bar 160, or by using any other conventional method.

The active debug dialog box 200 displays control variables that are associated with the selected dialog block. The active debug dialog box 200 also displays the real-time state of the variable, the global variable name and a short name. In an alternate embodiment, the active debug dialog box 200 can indicate whether the control variable is an actual value or a user-defined value using symbols, fonts, colors, bolding, etc. For example, actual values can be designated “A” and user-defined variables can be designated “U”. Using the mouse and/or the keyboard, the user highlights and selects a control variable. By selecting and double-clicking on the selected control variable, a second active debug dialog box 220 in FIG. 7 is launched. Alternately, the active debug dialog box 200 can provide command buttons such as “OK”, “Clear”, “Select” and/or “Cancel” or any other conventional selection method for launching the dialog box 220 in FIG. 7.

The active debug dialog box 220 in FIG. 7 contains several options for changing the value of the selected control variable. If additional user input is required, an additional dialog box is launched. A “Set Value” option launches a third dialog box 240 that is illustrated in FIG. 8. Other selections do not require further input. A “Zero Value” option sets the value of the control variable to zero. A “Force On” option forces “On” the selected “On/Off” control variable. A “Force Off” option forces the “On/Off” control variable to an “Off” state. An unforce option unforces a previously forced “On/Off” control variable.

Depending upon the data type of the selected control variable, certain options illustrated in FIG. 7 may be disabled. For example, if variable “aaaaaaaaaaaa” is selected and is an “On/Off” data type, the “Set Value” and “Zero Value” options are preferably disabled. Skilled artisans can appreciate that there are a variety of suitable ways to implement the second active dialog box 220 in FIG. 7.

Referring now to FIG. 8, when the “Set Value” option is selected in the dialog box 220, the third dialog box 240 is launched so that a new value can be entered using a text box 242 for the selected control variable. Command buttons 244 and 246 provide conventional “OK” and “Cancel” functions. Referring now to FIG. 9, when the selected control variable is the “On/Off” control variable type, a fourth dialog box 260 is launched. The developer selects between “Force On”, “Force Off” and “Unforce” options. Once a control variable is altered, the logic block and/or control variable dialog boxes 200, 220, 240 and 260 can be designated with a special icon, color, font, shading or other suitable designation to indicate that a control variable has been changed or forced.

As can be appreciated from the foregoing, the machine programming and control system according to the present invention allows a programmer to remotely view control variables that are associated with logic blocks of a flowchart. The control variables can be forced to a state or value, unforced and/or set to zero. The present invention simplifies and facilitates the debugging of flowcharts containing control logic for operating devices that are associated with a process.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. A flowchart-based programming and control system comprising:
a computer including a processor, memory and a display;
a device that is connected to said computer and is associated with a process; and
a flowcharting module run by said computer that generates and edits a flowchart that includes flowchart blocks and that contains logic for operating said device to further said process,
wherein said flowcharting module includes a debugging mode that displays said flowchart and identifies a flowchart block that is currently being executed, and wherein said debugging mode displays a value of a control variable that is associated with a selected flowchart block.

2. The flowchart-based programming and control system of claim 1 wherein said debugging mode allows said value of said control variable to be changed.

3. The flowchart-based programming and control system of claim 2 wherein said debugging mode allows said value of said control variable to be forced on.

4. The flowchart-based programming and control system of claim 2 wherein said debugging mode allows said value of said control variable to be forced off.

5. The flowchart-based programming and control system of claim 2 wherein said debugging mode allows said value of said control variable to be set to zero.

6. The flowchart-based programming and control system of claim 2 wherein said debugging mode allows said value of said control variable to be set to a new value.

7. The flowchart-based programming and control system of claim 2 wherein said debugging mode provides a control variable reset function.

8. A flowchart-based programming and control system comprising:
a computer including a processor, memory and a display;
a device that is connected to said computer and is associated with a process; and
a flowcharting module run by said computer that generates and edits a flowchart that includes flowchart blocks, that contains logic for operating said device to further said process, that includes:
a debugging mode that displays said flowchart and identifies a flowchart block that is currently being executed, that displays a value of a control variable that is associated with a selected flowchart block, and wherein said debugging mode allows said value of said control variable to be one of changed, forced on, forced off, set to zero, and set to a new value.

9. The flowchart-based programming and control system of claim 8 wherein said debugging mode provides a control variable reset function.

10. A method of operating a flowchart-based programming and control system comprising:
providing a computer including a processor, memory and a display;
connecting a device that is associated with a process to said computer; and
generating and editing a flowchart that includes flowchart blocks and that contains logic for operating said device to further said process;
providing a debugging mode that displays said flowchart;
identifying a flowchart block that is currently being executed using said debugging mode; and
displaying a value of a control variable that is associated with a selected flowchart block.

11. The method of claim 10 further comprising allowing said value of said control variable to be changed.

12. The method of claim 11 further comprising allowing said value of said control variable to be forced on.

13. The method of claim 11 further comprising allowing said value of said control variable to be forced off.

14. The method of claim 11 further comprising allowing said value of said control variable to be set to zero.

15. The method of claim 11 wherein said debugging mode allows said value of said control variable to be set to a new value.

16. The method of claim 11 further comprising providing a control variable reset function.
